(19) United States
(12) Patent Application Publication
(10) Pub. No.: US 2023/0176917 A1
(43) Pub. Date: Jun. 8, 2023

(54) METHODS AND APPARATUS TO GENERATE AND MANAGE LOGICAL WORKLOAD DOMAINS IN A COMPUTING ENVIRONMENT

(71) Applicant: VMWARE, INC., Palo Alto, CA (US)

(72) Inventors: NAREN LAL, Bangalore (IN); KALYAN DEVARAKONDA, Bangalore (IN); RANGANATHAN SRINIVASAN, Bangalore (IN)

(21) Appl. No.: 17/591,625

(22) Filed: Feb. 3, 2022

(30) Foreign Application Priority Data
Dec. 7, 2021 (IN) 202141056799

(51) Int. Cl. G06F 9/50; H04L 9/40

(52) U.S. Cl. CPC G06F 9/505; H04L 63/20

(57) ABSTRACT

Methods, apparatus, systems, and articles of manufacture are disclosed to generate and manage logical workload domains. An example apparatus includes at least one memory, instructions in the apparatus, and processor circuitry to execute the instructions to: obtain a request to perform a service on a logical workload domain, the logical workload domain logically grouping at least two or more workload domains based on a criterion, identify the at least two or more workload domains grouped in the logical workload domain, and concurrently orchestrate the service on the at least two or more workload domains.

### RELATED APPLICATION

Benefit is claimed under 35 U.S.C. 119(a)-(d) to Foreign Application Serial No. 202141056799 filed in India entitled “METHODS AND APPARATUS TO GENERATE AND MANAGE LOGICAL WORKLOAD DOMAINS IN A COMPUTING ENVIRONMENT”, on Dec. 7, 2021, by VMware, Inc., which is herein incorporated in its entirety by reference for all purposes.

### FIELD OF THE DISCLOSURE

This disclosure relates generally to logical workload domains and, more particularly, to methods and apparatus to generate and manage logical workload domains in a computing environment.

### BACKGROUND

A software-defined data center (SDDC) is a data center implemented by software in which hardware is virtualized and provided to users as services. SDDCs allow for dynamically configuring and deploying applications and resources per customer requests and per customer-defined specifications and performances.

### BRIEF DESCRIPTION OF THE DRAWINGS

FIG. 1 is a block diagram of an example logical workload domain (LWD) system to create and manage logical workload domains.

FIG. 2 is a block diagram of example LWD management circuitry of the LWD system of FIG. 1 to configure and deploy LWDs.

FIG. 3 is a block diagram of example LWD operator circuitry of the LWD system of FIG. 1 to apply policies and updates to deployed LWDs.

FIG. 4 is a block diagram of a logical workload domain service interaction to apply and/or utilize microservices for a LWD.

FIG. 5 is a flowchart representative of example machine readable instructions that may be executed by example processor circuitry to implement the example LWD system of FIG. 1 and the example LWD management circuitry of FIGS. 1 and 2 to configure and deploy workload domains and logical workload domains.

FIG. 6 is a flowchart representative of example machine readable instructions that may be executed by example processor circuitry to implement the example LWD system of FIG. 1 and the example LWD operator circuitry of FIGS. 1 and 3 to perform a service on one or more LWDs.

FIGS. 7A, 7B, 7C, 7D, and 7E depict example user interface (UI) visualizations corresponding to an example SDDC manager, which manages the example LWD system of FIG. 1.

FIG. 8 is a block diagram of an example processing platform including processor circuitry structured to execute the example machine readable instructions of FIGS. 5-6 to implement the example LWD system 100 of FIG. 1.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 5-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

An SDDC environment typically requires configuration of compute resources, network resources, storage resources, and security protocols. An SDDC executes workload domains in accordance with resource configurations corresponding to these workload domains. As used herein, a workload domain is a policy-based resource container with specific availability and performance attributes that combines virtual compute resources, virtual storage resources, and virtual network resources into a useable execution environment. In examples disclosed herein, a workload domain is deployed in a virtualization environment and used to execute deployed applications.

In some examples, an SDDC environment includes, manages, and deploys a plurality of workload domains. In such an example, at least some, if not all, of the plurality of workload domains are homogenous. In some examples, when workload domains are homogenous, the workload domains share the same hardware and/or virtual resources (e.g., servers, memory, etc.). For example, when a first workload domain is created for an SDDC to deploy and manage, the first workload domain is assigned to a set of one or more servers (e.g., physical and/or virtual servers) that are managed by the SDDC. Similarly, when a second workload domain is created for the SDDC to deploy and manage, the second workload domain is assigned to the set of one or more servers (e.g., physical and/or virtual). In this example, the first and second workload domain may have separate functions (e.g., execute different applications), but they utilize the same compute resources. In some examples, the first and second workload domains may operate in conjunction with each other. The operation of the individual workload domains is determined by a user creating their virtual environment and, thus, may function in any way desired and known by the user. In some examples, when there are 10, 20, 50, 100, or any number of workload domains deployed by the SDDC, it becomes cumbersome to manage. For example, updating policies of the SDDC, updating firmware versions, etc., may take a significant amount of time to perform, because every individual workload domain will require the updates.

Examples disclosed herein group workload domains into logical workload domains (LWDs) to facilitate management of the group of workload domains as one unit instead of management of individual workload domains. The LWDs enable firmware updates to occur at the LWD level, password management and other security policy updates at the LWD level, certificate management at the LWD level, and configuration and backup restore management at the LWD level. The SDDC and/or users of the workload domains are provided with easier and quicker methods for managing different updates and policies when the workload domains are grouped into LWDs.

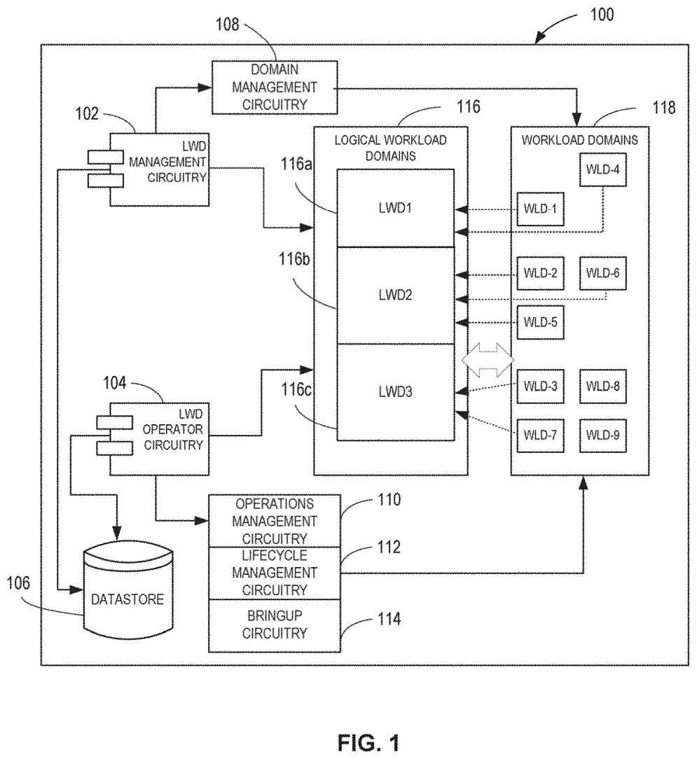

FIG. 1 is a block diagram of an example logical workload domain (LWD) system 100 to create and manage logical workload domains. The example LWD system 100 includes example logical workload domain (LWD) management circuitry 102, example logical workload domains (LWD) operator circuitry 104, an example datastore 106, example domain management circuitry 108, example operations management circuitry 110, example lifecycle management circuitry 112, example bringup circuitry 114, example logical workload domains (LWD) 116a, 116b, and 116c, collectively LWDs 116, and example workload domains 118.

The example LWD system 100 is a system that operates on top of or outside of one or more virtual server racks. The example LWD system 100 is a high-level management system that facilitates the creation of LWDs 116 and that facilitates the management of the LWDs 116. For example, the LWD system 100 includes components that configure resources, facilitate updates, configures security protocols, etc. For example, the LWD system 100 configures, deploys, and upgrades logical workload domains 116. The example LWD system 100 may be implemented by a physical server, a virtual server, and/or a combination thereof.

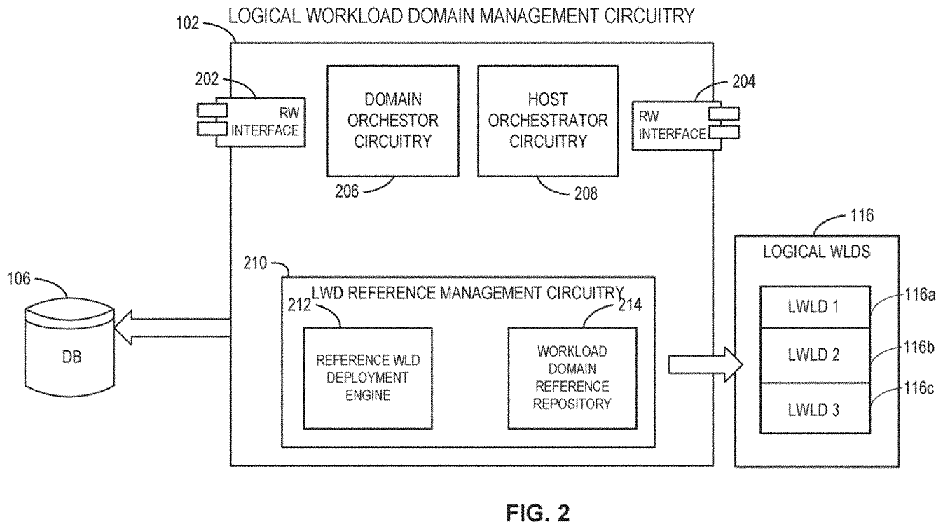

The example LWD system 100 includes the example LWD management circuitry 102 to configure and deploy LWDs 116. The example LWD management circuitry 102 includes at least one read/write connection that may be connected to a network to receive API calls. For example, the LWD management circuitry 102 communicates with an SDDC manager, controlled by a user, to create LWDs 116, remove LWDs 116, etc. In the illustrated example, the LWD management circuitry 102 is to retrieve reference configuration templates from the datastore 106 and configure the LWDs 116 based on settings of the retrieved reference configuration templates. The example LWD management circuitry 102 selects a reference configuration template based on instructions from API calls. The example LWD management circuitry 102 may select a reference configuration template based on a type (e.g., a banking type, a web server type, a media streaming type, etc.) of the application that will be deployed in the workload domain and/or based on the LWD 116 to which the workload domain is to belong, which may be determined based on user input. The example LWD management circuitry 102 is described in further detail below in connection with FIG. 2.

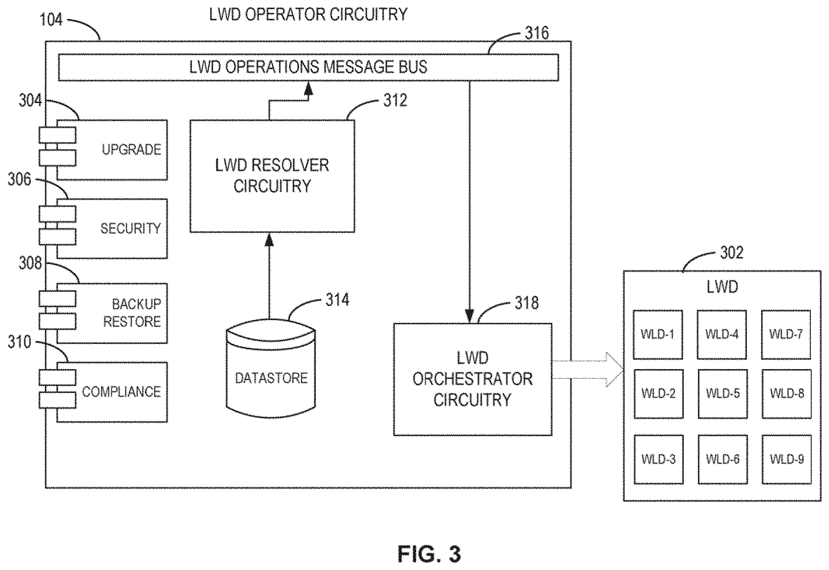

The example LWD system 100 includes the example LWD operator circuitry 104 to apply policies and to update deployed LWDs 116. For example, the LWD operator circuitry 104 facilitates applying security policies, managing upgrades, performing backup and restore operations, and applying compliance updates at the LWD level. The example LWD operator circuitry 104 can simultaneously and/or concurrently orchestrate a service for all workload domains within a LWD 116 and, thus, decrease an amount of time spent on orchestrating the service to individual workload domains 118. As used herein, orchestrating is defined as the creation, management, manipulation and/or decommissioning of cloud resources, (e.g., computing, storage, and/or networking resources), in order to realize customer computing requests (e.g., processing requests, hosting requests, etc.), while conforming to operational objectives of cloud service providers. Orchestrating a service includes managing, manipulating, and/or decommissioning cloud resources corresponding to one or more logical workload domains (e.g., the cloud resources making up the logical workload domains) in order to instantiate (e.g., realize) the service. The example LWD operator circuitry 104 is described in further detail below in connection with FIG. 3.

The example LWD system 100 includes the example datastore 106 which includes and/or stores reference configuration templates (workload domain configuration templates). Reference configuration templates provide configuration settings for the workload domains 118. As used herein, a configuration template is a data file that stores general configuration settings for workload domains 118. In examples disclosed herein, the configuration templates are used by the LWD management circuitry 102 and/or the domain management circuitry 108 to initially configure the workload domains and LWDs 116. Multiple configuration templates with different settings may be provided for different workload domains 118 such as, for example, a workload domain for using a banking application, a workload domain for using a streaming service application, etc. In some examples, the reference configuration templates include metadata indicative of which logical workload domain 116a, 116b, 116c the reference configuration templates correspond to. For example, a first reference configuration template may be a replica of a workload domain in a first LWD 116a and a second reference configuration template may be a replica of a workload domain in a second LWD 116b. The example datastore 106 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 106 may additionally or alternatively be implemented by one or more double data rate (DDR) memories, such as DDR, DDR2, DDR3, DDR4, mobile DDR (mDDR), etc. The datastore 106 may additionally or alternatively be implemented by one or more mass storage devices such as hard disk drive(s), compact disk (CD) drive(s), digital versatile disk (DVD) drive(s), solid-state disk drive(s), etc. While in the illustrated example the datastore 106 is illustrated as a single datastore, the datastore 106 may be implemented by any number and/or type(s) of datastores. Furthermore, the data stored in the datastore 106 may be in any data format such as, for example, binary data, comma delimited data, tab delimited data, structured query language (SQL) structures, etc.

The example LWD system 100 includes the example domain management circuitry 108 to configure and deploy the workload domains 118. The example domain management circuitry 108 is connected to the LWD management circuitry 102 to receive instructions corresponding to configuration of the workload domains 118. For example, the domain management circuitry 108 obtains instructions to configure workload domains 118 that are not to be grouped into a LWD. The example domain management circuitry 108 of the illustrated example of FIG. 1 is provided to retrieve reference configuration templates from the datastore 106 and configure the workload domains 118 based on settings of the retrieved reference configuration templates. The example domain management circuitry 108 selects a reference configuration template based on instructions from the LWD management circuitry 102. The example LWD management circuitry 102 may select a reference configuration template based on a type (e.g., a banking type, a web server type, a media streaming type, etc.) of the application that will be deployed in the workload domain, which may be determined based on user input.

The example LWD system 100 includes the example operations management circuitry 110 to perform individual operations on individual workload domains when a workload domain does not belong to a LWD. For example, some workload domains may not be configured to be included in a group of workload domains (e.g., logical workload domains). As such, the example operations management circuitry 110 is provided to apply operations to the workload domain not included in a LWD. In some examples, the LWD operator circuitry 104 may receive a request from an SDDC manager to perform an operation on workload domain n, and further determine that the workload domain n is not included in any LWD. In such examples, the LWD operator circuitry 104 initiates the operations management circuitry 110 to perform the operation on the workload domain n.

The example LWD system 100 includes the example lifecycle management circuitry 112 to perform individual upgrades on individual workload domains when a workload domain does not belong to a LWD. The example lifecycle management circuitry 112 obtains requests and/or instructions from the LWD operator circuitry 104 to apply upgrades to workload domains. In some examples, the LWD operator circuitry 104 may receive a request from an SDDC manager to upgrade a workload domain n, and further determine that the workload domain n is not included in any LWD. In such examples, the LWD operator circuitry 104 initiates the lifecycle management circuitry 112 to upgrade the workload domain n.

The example LWD system 100 includes the example bringup circuitry 114 to set up and/or configure and deploy the components of the LWD system 100. For example, the bringup circuitry 114 configures virtual machines, hypervisors, and other dependent components required to operate a management system. The example bringup circuitry 114 “brings up” the LWD system 100. As used herein, to “bring up” a system means to perform a process of configuring hardware, firmware, and/or software elements, testing the elements, validating the elements, and debugging the elements in order to achieve readiness for a user.

The example LWD system 100 includes the example LWDs 116, which are one or more logical groupings of a number of workload domains grouped based on certain criteria. In some examples, the criterion for grouping is based on applications that are to run on the workload domains. For example, workload domains utilized for a banking application may be grouped together, workload domains used for a streaming service application may be grouped together, etc. In some examples, the criterion for grouping is based on user choices. For example, if a user wants particular workload domains to be handled simultaneously and/or concurrently (e.g., managed at one time), the user can select which workloads to group together.

In FIG. 1, the LWD system 100 includes an example deployment of workload domains and LWDs. For example, the LWD system 100 include a deployment of a first LWD 116a, a second LWD 116b, and a third LWD 116c. The example first LWD 116a includes an example workload domain 1 (WLD-1) and an example workload domain 4 (WLD-4) of the workload domains 118. The example second LWD 116b includes an example workload domain 2 (WLD-2), an example workload domain 5 (WLD-5), and an example workload domain 6 (WLD-6) of the workload domains 118. The example third LWD 116c includes an example workload domain 3 (WLD-3) and an example workload domain 7 (WLD-7). The workload domains 118 include an example workload domain 8 (WLD-8) and an example workload domain 9 (WLD-9), which do not correspond to LWDs 116.

In the illustrated example of FIG. 1, the example deployment of workload domains, there are three LWDs (e.g., 116a, 116b, and 116c) that constitute seven of the workload domains, and the remaining (e.g., workload domain 8 (WLD-8) and workload domain 9 (WLD-9)) are managed independently. In some examples, when a particular generation of hardware is added to a data center (e.g., a location that houses core information technology and computing services and infrastructure), there are n same generations of servers added to a cloud management instance (e.g., VMware Cloud Foundation®). In such examples, the cloud management instance includes an SDDC and the example LWD system 100. As such, the n same generations of servers are deployed as three workload domains (e.g., as workload domain 2 (WLD-2), workload domain 5 (WLD-5), and workload domain 6 (WLD-6)). These three workload domains would require firmware updates at the same or similar times, lifecycle upgrades at the same time, etc. Therefore, these three workload domains can be grouped by the LWD management circuitry 102 and deployed together as the second LWD 116b. The example LWD system 100 ensures that by grouping the three workload domains together as the second LWD 116b, baselining and management of the n servers can be handled in one place.

In some examples, another deployment of a group of workload domains are configured to follow the same security policy. In some examples, when a user configures workload domains to follow the same security policy, the LWD management circuitry 102 can identify this criterion and group the workload domains into a LWD. For example, the first LWD 116a includes workload domain 1 (WLD-1) and workload domain 4 (WLD-4), which are both configured to follow the same security policy. Therefore, the first LWD 116a is created based on the security policy criterion. By creating the first LWD 116a based on the security policy, the example LWD operator circuitry 104 is enabled to configure updates and security policies in one place instead of configuring two workload domains separately.

In some examples, the LWD management circuitry 102 is configured to group the workload domain based on an application criteria. As such, the example workload domain 1 (WLD-1) and the example workload domain 4 (WLD-4) execute parts of the same application. The example LWD management circuitry 102 may analyze configuration settings of the workload domains 118 to determine that workload domain 1 (WLD-1) and workload domain 4 (WLD-4) execute parts of the same application. In some examples, the configuration settings include a job title of the workload domain. For example, both the workload domain 1 (WLD-1) and workload domain 4 (WLD-4) include information indicating their job title is JOB 1. The example LWD management circuitry 102 creates the first LWD 116a to be consumed as a resource for JOB 1. For example, the LWD management circuitry 102 encloses the set of workload domains (e.g., workload domain 1 (WLD-1) and workload domain 4 (WLD-4)) in the first LWD 116a as a set of workload domains that can be managed together as a single entity.

FIG. 2 is an example block diagram of the LWD management circuitry 102 of FIG. 1 to configure and deploy LWDs 116. The example LWD management circuitry 102 includes an example first read/write (RW) interface 202, an example second RW interface 204, example domain orchestrator circuitry 206, example host orchestrator circuitry 208, and an example LWD reference management circuitry 210.

In the illustrated example of FIG. 2, the example LWD management circuitry 102 includes the first RW interface 202 to obtain instructions from an example SDDC manager and/or any type of management platform that enables a user to create and control workload domains. Additionally and/or alternatively, the example first RW interface 202 is to send instructions to the example domain orchestrator circuitry 206. The instructions communicated by the example first RW interface 202 include instructions to create LWDs 116, instructions to move workload domains from one LWD to another, and to remove LWDs. In this example, the first RW interface 202 is implemented by a create, read, upload, and delete (CRUD) plugin box. A CRUD plugin box is implemented using an API that enables a program to submit API calls to the CRUD plugin box to create and control workload domains.

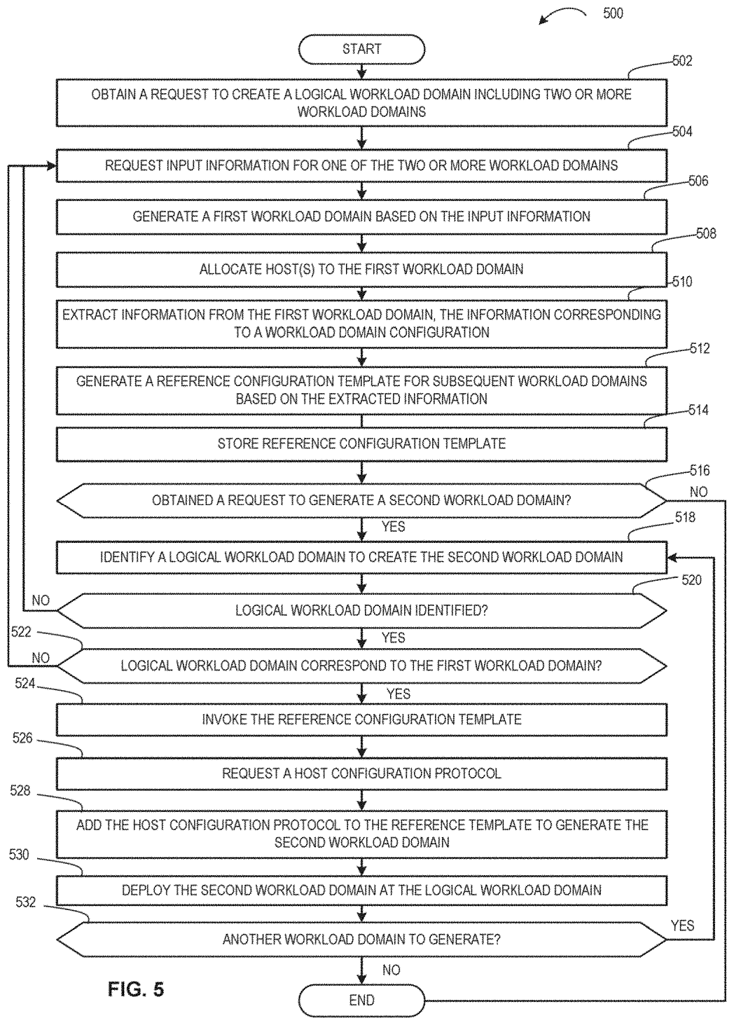

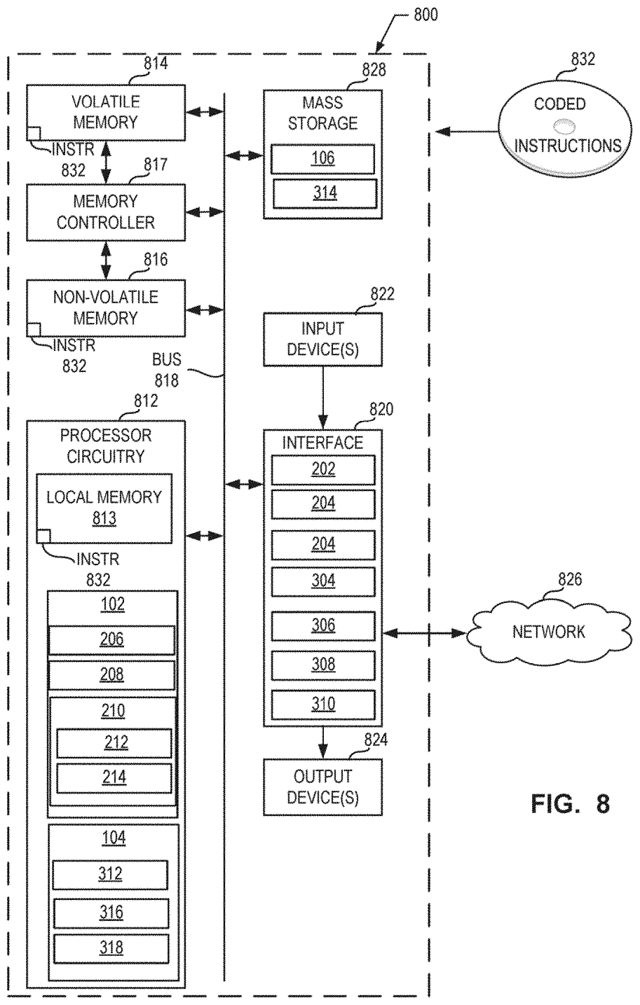

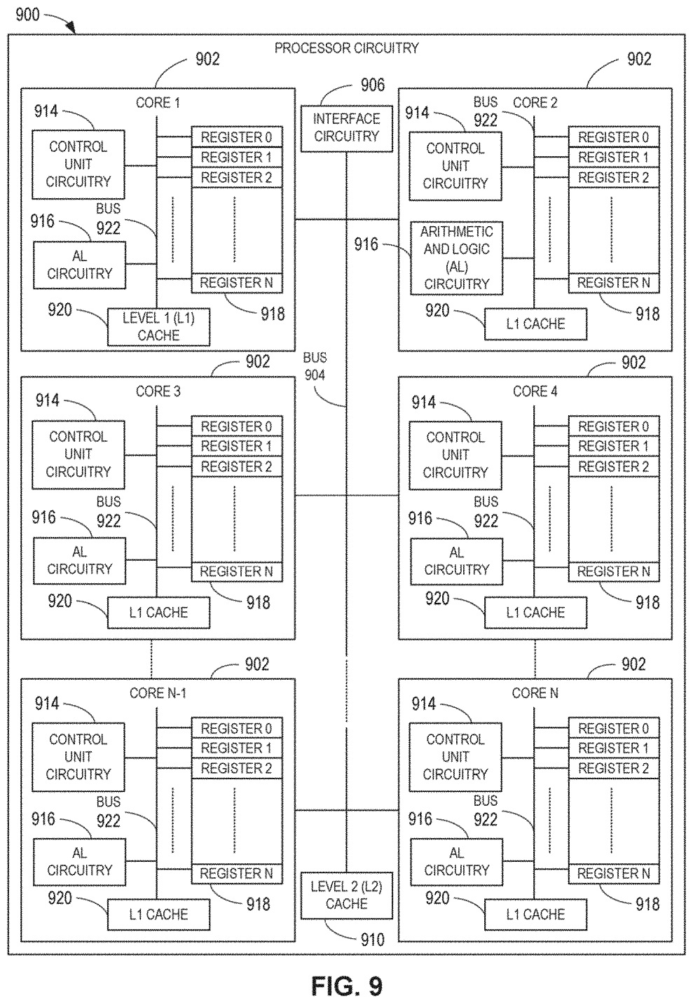

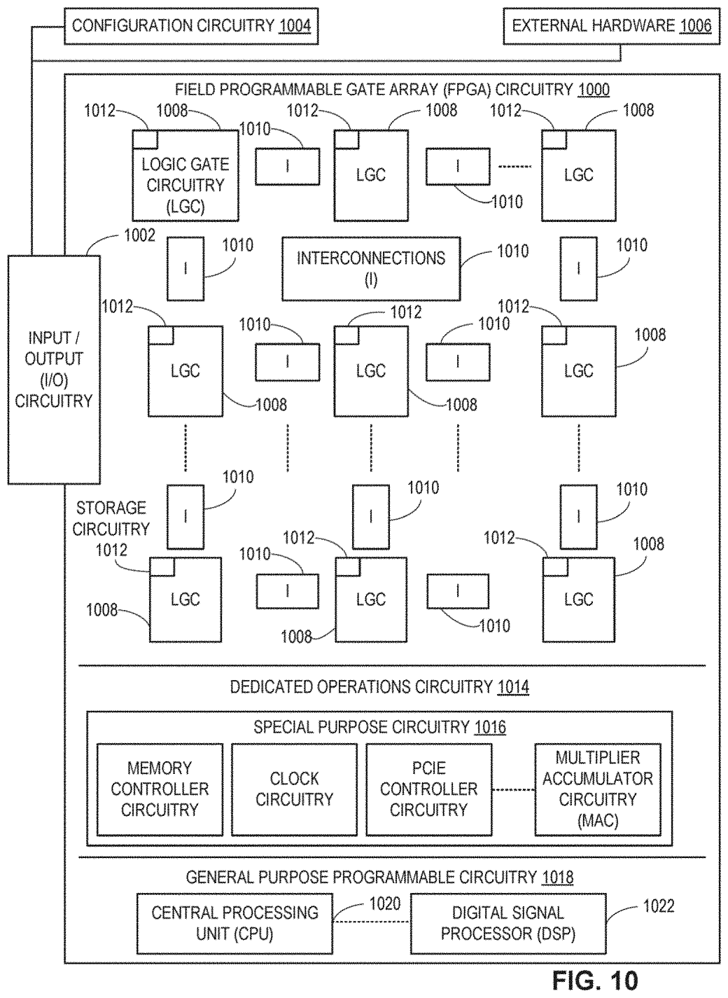

In some examples, the first RW interface 202 includes means for obtaining requests. In some examples, the first RW interface 202 may be implemented by machine executable instructions such as that implemented by at least blocks 502, 504, 516, and/or 526 of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the first RW interface 202 is implemented by other hardware logic circuitry, hardware implemented state machines, and/or any other combination of hardware, software, and/or firmware. For example, the first RW interface 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example LWD management circuitry 102 includes the example second RW interface 204 to obtain instructions from the example host orchestrator circuitry 208. Additionally and/or alternatively, the example second RW interface 204 provides instructions to hosts, such as a host server that workload domains 118 run and/or execute on. In this example, the second RW interface 204 is implemented by a create, read, upload, and delete (CRUD) plugin box. The CRUD plugin box is implemented using an API that enables a program to submit API calls to the CRUD plugin box to manage hosts.

In some examples, the second RW interface 204 includes means for obtaining requests. In some examples, the second RW interface 204 may be implemented by machine executable instructions such as that implemented by at least blocks 508 and/or 526 of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the second RW interface 204 is implemented by other hardware logic circuitry, hardware implemented state machines, and/or any other combination of hardware, software, and/or firmware. For example, the second RW interface 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example LWD management circuitry 102 includes the example domain orchestrator circuitry 206 to orchestrate the creation, deletion, and/or relocation of the example LWDs 116. The example domain orchestrator circuitry 206 obtains instructions from the example first RW interface 202. The instructions may include user initiated instructions, such as create LWD1 116a. In some examples, the domain orchestrator circuitry 206 provides instructions to a user, via the first RW interface 202. Such instructions may include a request for more information from the user to create the LWD1 116a. The example domain orchestrator circuitry 206 may obtain and/or request application criteria for a workload domain 118 to determine where the workload domain 118 should be grouped. For example, the domain orchestrator circuitry 206 utilizes application criteria to group a workload domain 118 into a LWD 116 that includes other workload domains with the same or similar criteria. The example domain orchestrator circuitry 206 can move a workload domain from one LWD to a different LWD. The example domain orchestrator circuitry 206 can remove LWDs 116. In some examples, domain orchestrator circuitry 206 may be instructed to remove a LWD. In some examples, the domain orchestrator circuitry 206 identifies that a LWD can be removed, such as when workload domains are inactive.

In some examples, the domain orchestrator circuitry 206 includes means for orchestrating logical workload domains. In some examples, the domain orchestrator circuitry 206 may be implemented by machine executable instructions such as that implemented by at least blocks 504, 518, 520, and/or 522 of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the domain orchestrator circuitry 206 is implemented by other hardware logic circuitry, hardware implemented state machines, and/or any other combination of hardware, software, and/or firmware. For example, the domain orchestrator circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example LWD management circuitry 102 includes the host orchestrator circuitry 208 to orchestrate the hosts that the LWDs 116 are executing on and/or consuming resources from. The example host orchestrator circuitry 208 provides instructions to the example second RW interface 204. Such instructions may include where to allocate hosts. For example, a workload domain may utilize one or more hosts. The hosts include resources (e.g., physical hardware resources, virtual resources, etc.) that are consumed and/or utilized by the workload domains. In some examples, a host assigned to a workload domain in a LWD may be underutilized (e.g., the resources aren't used with their full potential). In some examples, a host assigned to the same workload domain and/or a workload domain in the same LWD is overutilized (e.g., the resources are used to their full potential). In such examples, the host orchestrator circuitry 208 identifies the underutilized host and assigns it to a workload domain that is overutilizing a different host. The LWD 116 makes it possible for the host orchestrator circuitry 208 to move hosts around workload domains because the workload domains within a single LWD 116 are managed together and identified as a single entity.

In some examples, the host orchestrator circuitry 208 includes means for orchestrating hosts. In some examples, the host orchestrator circuitry 208 may be implemented by machine executable instructions such as that implemented by at least blocks 508 of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the host orchestrator circuitry 208 is implemented by other hardware logic circuitry, hardware implemented state machines, and/or any other combination of hardware, software, and/or firmware. For example, the host orchestrator circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example LWD management circuitry 102 includes the example LWD reference management circuitry 210 to obtain, provide, and/or create reference configuration templates. The example LWD reference management circuitry 210 obtains instructions and/or communications from the first RW interface 202. Such instructions and/or communications identify which reference configuration template(s) to select, create, deploy, etc. The example LWD reference management circuitry 210 includes an example reference workload domain deployment engine 212 and an example workload domain reference repository 214.

In the illustrated example of FIG. 2, the example LWD reference management circuitry 210 includes the example reference workload domain deployment engine 212 to configure workload domains (e.g., the workload domains 118) for deployment based on reference configuration templates. In the illustrated example, the reference workload domain deployment engine 212 configures a workload domain based on information obtained from the first RW interface 202. In such examples, the reference workload domain deployment engine 212 notifies the domain orchestrator circuitry 206 to deploy the configured workload domain and notifies the host orchestrator circuitry 208 to assign hosts and/or create a host for the workload domain. Additionally and/or alternatively, the example reference workload domain deployment engine 212 deploys the workload domains. In such examples, the reference workload domain deployment engine 212 deploys a workload domain to be assigned and/or grouped in a LWD 116. Additionally and/or alternatively, the domain orchestrator circuitry 206 moves, groups, and/or assigns the deployed workload domain to a LWD 116.

In some examples, the reference workload domain deployment engine 212 includes means for configuring workload domains and/or deploying workload domains. In some examples, the reference workload domain deployment engine 212 may be implemented by machine executable instructions such as that implemented by at least blocks 506, 510, 512, 524, 528, and/or 530, of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the reference workload domain deployment engine 212 is implemented by other hardware logic circuitry, hardware implemented state machines, and/or any other combination of hardware, software, and/or firmware. For example, the reference workload domain deployment engine 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 2, the example LWD reference management circuitry 210 includes the example workload domain reference repository 214 to maintain a list of LWDs 116. In some examples, the reference workload domain deployment engine 212 utilizes information (e.g., list of LWDs 116) stored in the workload domain reference repository 214 to create and deploy workload domains. In some examples, the workload domain reference repository 214 may be implemented by the datastore 106. Additionally and/or alternatively, the example workload domain reference repository 214 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example workload domain reference repository 214 may additionally or alternatively be implemented by one or more double data rate (DDR) memories, such as DDR, DDR2, DDR3, DDR4, mobile DDR (mDDR), etc. The workload domain reference repository 214 may additionally or alternatively be implemented by one or more mass storage devices such as hard disk drive(s), compact disk (CD) drive(s), digital versatile disk (DVD) drive(s), solid-state disk drive(s), etc. While in the illustrated example the workload domain reference repository 214 is illustrated as a single datastore, the workload domain reference repository 214 may be implemented by any number and/or type(s) of datastores. Furthermore, the data stored in the workload domain reference repository 214 may be in any data format such as, for example, binary data, comma delimited data, tab delimited data, structured query language (SQL) structures, etc.

In some examples, the workload domain reference repository 214 includes means for storing metadata and/or information indicative of deployed LWDs 116. In some examples, the workload domain reference repository 214 may be implemented by machine executable instructions such as that implemented by at least blocks 514 of FIG. 5 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the workload domain reference repository 214 is implemented by other hardware logic circuitry, hardware implemented state machines, and/or any other combination of hardware, software, and/or firmware. For example, the workload domain reference repository 214 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the LWD management circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example first RW interface 202, the example second RW interface 204, the example domain orchestrator circuitry 206, the example host orchestrator circuitry 208, the example LWD reference management circuitry 210, the example reference workload deployment engine 212, the example workload domain reference repository 214, and/or, more generally, the example LWD management circuitry 102 of FIG. 1, may be implemented by hardware, software, firmware, and/or any combination of hardware, software, and/or firmware. Thus, for example, any of the example first RW interface 202, the example second RW interface 204, the example domain orchestrator circuitry 206, the example host orchestrator circuitry 208, the example LWD reference management circuitry 210, the example reference workload deployment engine 212, the example workload domain reference repository 214, and/or, more generally, the example LWD management circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example first RW interface 202, the example second RW interface 204, the example domain orchestrator circuitry 206, the example host orchestrator circuitry 208, the example LWD reference management circuitry 210, the example reference workload deployment engine 212, and/or the example workload domain reference repository 214, is/are hereby expressly defined to include a non-transitory computer readable storage device or storage disk such as a memory, a digital versatile disk (DVD), a compact disk (CD), a Blu-ray disk, etc., including the software and/or firmware. Further still, the example LWD management circuitry 102 of FIG. 1 may include one or more elements, processes, and/or devices in addition to, or instead of, those illustrated in FIG. 2, and/or may include more than one of any or all of the illustrated elements, processes and devices.

FIG. 3 is a block diagram of the example LWD operator circuitry 104 of FIG. 1 to apply policies and updates to deployed LWDs 116. In the illustrated example, the LWD operator circuitry 104 applies policies and updates to an example LWD 302. The example LWD 302 includes example workload domain 1 (WLD-1), example WLD-2, example WLD-3, example WLD-4, example WLD-5, example WLD-6, example WLD-7, example WLD-8, and example WLD-9. In the illustrated example of FIG. 3, when a policy, update, etc., is applied to the LWD 302, the policy, update, etc., is applied to all of the example workload domains included in the LWD 302 (e.g., WLD-1, WLD-2, WLD-3, WLD-4, WLD-5, WLD-6, WLD-7, WLD-8, WLD-9). The example LWD operator circuitry 104 includes an example upgrade interface 304, an example security interface 306, an example backup restore interface 308, an example compliance interface 310, example LWD resolver circuitry 312, an example datastore 314, an example LWD operations message bus (LWD bus) 316, and example LWD orchestrator circuitry 318.

In the illustrated example of FIG. 3, the LWD operator circuitry 104 includes the example upgrade interface 304 to obtain instructions, from an SDDC manager and/or any type of management circuitry, indicative to apply an upgrade to the LWD 302. Additionally and/or alternatively, the example upgrade interface 304 is to send instructions to the example LWD resolver circuitry 312. The instructions communicated by the example upgrade interface 304 include instructions to upgrade at least one or more of the workload domains (WLD-1, WLD-2, WLD-3, WLD-4, WLD-5, WLD-6, WLD-7, WLD-8, WLD-9) from a current version to a new version. In some examples, a user may wish to upgrade workload domains from one version to a new version. In this example, the upgrade interface 304 is implemented by a create, read, upload, and delete (CRUD) plugin box. The CRUD plugin box is implemented using an API that enables a program to submit API calls to the CRUD plugin box to upgrade logical workload domains.

In the illustrated example of FIG. 3, the LWD operator circuitry 104 includes the example security interface 306 to obtain instructions, from an SDDC manager and/or any type of management circuitry, indicative to update security settings of the LWD 302. Additionally and/or alternatively, the example security interface 306 is to send instructions to the example LWD resolver circuitry 312. The instructions communicated by the example security interface 306 include instructions to update security policies and/or security settings corresponding to the at least one or more workload domains (WLD-1, WLD-2, WLD-3, WLD-4, WLD-5, WLD-6, WLD-7, WLD-8, WLD-9). A security policy may include a set of rules and/or guidelines that the LWD 302 is to follow in order to maintain protection of the workload domains in the LWD 302 from cyber attacks, etc. Security settings may include passwords, user identifiers, etc. In this example, the security interface 306 is implemented by a create, read, upload, and delete (CRUD) plugin box. The CRUD plugin box is implemented using an API that enables a program to submit API calls to the CRUD plugin box to manage security protocols of logical workload domains.

In the illustrated example of FIG. 3, the LWD operator circuitry 104 includes the example backup restore interface 308 to obtain instructions, from an SDDC manager and/or any type of management circuitry, indicative to back up information and/or data stored in the LWD 302 and/or indicative to restore information and/or data at the LWD 302. Additionally and/or alternatively, the example backup restore interface 308 is to send instructions to the example LWD resolver circuitry 312. The instructions communicated by the example backup restore interface 308 include instructions indicative of when and/or how to backup and/or restore data at the at least one or more workload domains (WLD-1, WLD-2, WLD-3, WLD-4, WLD-5, WLD-6, WLD-7, WLD-8, WLD-9). In this example, the backup restore interface 308 is implemented by a create, read, upload, and delete (CRUD) plugin box. The CRUD plugin box is implemented using an API that enables a program to submit API calls to the CRUD plugin box to backup logical workload domains.

In the illustrated example of FIG. 3, the LWD operator circuitry 104 includes the example compliance interface 310 to obtain instructions, from an SDDC manager and/or any type of management circuitry, indicative to manage license and/or certifications of the LWD 302. Additionally and/or alternatively, the example compliance interface 310 is to send instructions to the example LWD resolver circuitry 312. The instructions communicated by the example compliance interface 310 include instructions indicative of who can access the at least one or more workload domains (WLD-1, WLD-2, WLD-3, WLD-4, WLD-5, WLD-6, WLD-7, WLD-8, WLD-9) and in what manner the at least one or more workload domains (WLD-1, WLD-2, WLD-3, WLD-4, WLD-5, WLD-6, WLD-7, WLD-8, WLD-9) can be accessed. In some examples, an administrator may add new users to a list of users who can access the workload domains. In some examples, an administrator may update a users' status, such as a modification status, a read only status, etc. In this example, the compliance interface 310 is implemented by a create, read, upload, and delete (CRUD) plugin box. The CRUD plugin box is implemented using an API that enables a program to submit API calls to the CRUD plugin box to manage licenses and/or certifications of logical workload domains.

In the illustrated example of FIG. 3, the LWD operator circuitry 104 includes the example LWD resolver circuitry 312 to identify which workload domains (WLD-1, WLD-2, WLD-3, WLD-4, WLD-5, WLD-6, WLD-7, WLD-8, WLD-9) or LWDs (e.g., LWD 302) the instructions and/or request, from any of the interfaces (e.g., the upgrade interface 304, the security interface 306, the backup restore interface 308, and/or the compliance interface 310), correspond to. For example, the LWD resolver circuitry 312 obtains the instructions from any one of the interfaces and analyzes the instructions to determine which workload domains in the LWD 302 that the instructions correspond to. In some examples, analyzing the instructions include identifying workload domain identifiers in the instructions. In some examples, a workload domain identifier may be a numerical value, an alpha-numeric value, a name, etc., that was given by a user to the workload domain when configuring the workload domain. In some examples, analyzing the instructions includes accessing identifying information in the request, the identifying information to identify the LWD and/or the workload domains as a target to perform the service.

In the illustrated example, the LWD resolver circuitry 312 submits a query to the datastore 314 based on the identifying information. For example, the LWD resolver circuitry 312 is to submit a query to the datastore 314 for a number of workload domains in the LWD 302, based on utilizing the identifying information (e.g., the workload domain identifiers), for names of the workload domains in the LWD 302, for current versions of the LWD 302, for current security policies of the workload domains in the LWD 302, etc. Based on the query, the LWD resolver circuitry 312 is to identify the logical workload domain and/or the workload domains as a target logical workload domain and/or target workload domains to perform the service of the request. In the illustrated example, the LWD resolver circuitry 312 provides instructions to the LWD orchestrator circuitry 318, via the LWD operations message bus (bus) 316, indicative of the service to perform and to which workload domains the service is to be performed on and/or for.

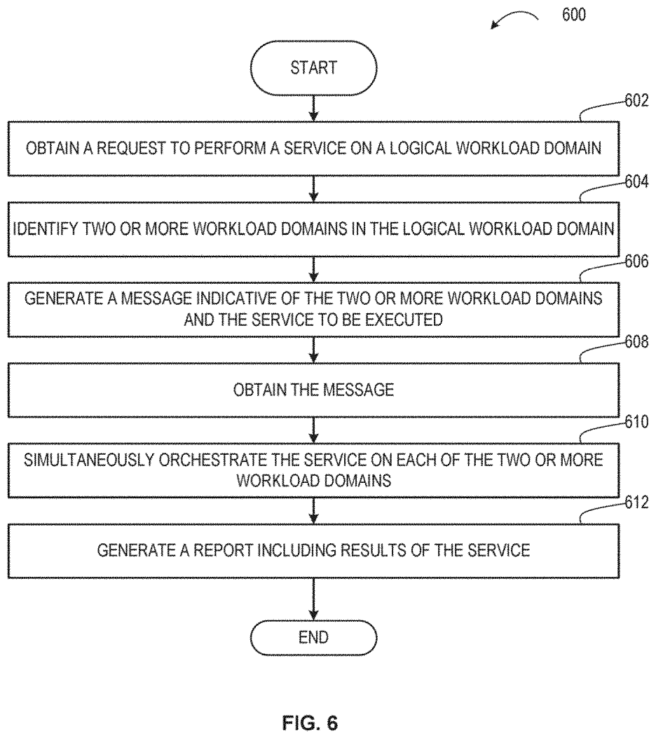

In some examples, the LWD resolver circuitry 312 includes means for resolving a LWD and/or one or more workload domains that an instruction and/or request is to apply to and/or means for identifying workload domains in the LWD. In some examples, the LWD resolver circuitry 312 may be implemented by machine executable instructions such as that implemented by at least blocks 604 of FIG. 6 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the LWD resolver circuitry 312 is implemented by other hardware logic circuitry, hardware implemented state machines, and/or any other combination of hardware, software, and/or firmware. For example, the LWD resolver circuitry 312 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 3, the LWD operator circuitry 104 includes the datastore 314 to store LWD information. LWD information includes workload domain configuration information, a number of workload domains in the LWD 302, etc. In some examples, the datastore 314 is to obtain updated LWD information in response to a new operation being applied to the workload domains. For example, the datastore 314 is to obtain a report of a result of the operation performed on and/or at the workload domains in the LWD 302. The datastore 314 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 314 may additionally or alternatively be implemented by one or more double data rate (DDR) memories, such as DDR, DDR2, DDR3, DDR4, mobile DDR (mDDR), etc. The datastore 314 may additionally or alternatively be implemented by one or more mass storage devices such as hard disk drive(s), compact disk (CD) drive(s), digital versatile disk (DVD) drive(s), solid-state disk drive(s), etc. While in the illustrated example the datastore 314 is illustrated as a single datastore, the datastore 314 may be implemented by any number and/or type(s) of datastores. Furthermore, the data stored in the datastore 314 may be in any data format such as, for example, binary data, comma delimited data, tab delimited data, structured query language (SQL) structures, etc.

In the illustrated example of FIG. 3, the LWD operator circuitry 104 includes the bus 316 to communicate operations and instructions from the LWD resolver circuitry 312 to the example LWD orchestrator circuitry 318. In the illustrated example, the bus 316 is implemented by a message broker. In the illustrated example, the bus 316 publishes the operations and/or instructions obtained by the LWD resolver circuitry 312. Once published, the example LWD orchestrator circuitry 318 can obtain the instructions and/or desired operations and apply them to the LWD 302. In some examples, the bus 316 provides the instructions and/or desired operations to the LWD orchestrator circuitry 318. In some examples, the LWD orchestrator circuitry 318 monitors the bus 316 and requests the instructions and/or operations.

In some examples, the LWD operations bus 316 includes means for communicating and/or publishing instructions and/or operations. In some examples, the LWD operations bus 316 may be implemented by machine executable instructions such as that implemented by at least blocks 606 of FIG. 6 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the LWD operations bus 316 is implemented by other hardware logic circuitry, hardware implemented state machines, and/or any other combination of hardware, software, and/or firmware. For example, the LWD operations bus 316 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In the illustrated example of FIG. 3, the LWD operator circuitry 104 includes the LWD orchestrator circuitry 318 to orchestrate operations corresponding to the LWD 302 based on instructions obtained from the bus 316. The example LWD orchestrator circuitry 318 is to apply an operation to any one of the workload domains that the LWD resolver circuitry 312 indicated were to be applied to. For example, the LWD resolver circuitry 312 determines that an upgrade to version 2.0 is to be applied to WLD-1, WLD-4, and WLD-8. The example LWD orchestrator circuitry 318 orchestrates the upgrade to version 2.0. In some examples, the LWD orchestrator circuitry 318 performs the operations in fewer clock cycles than operations for workload domains not included in a LWD. In some examples, the operation at each of the workload domains (WLD-1, WLD-4, WLD-8) occurs simultaneously and/or concurrently and, thus, are complete before operations applied individually to workload domains not in a LWD. In some examples, the LWD orchestrator circuitry 318 generates reports indicative of results of the operations applied to the LWD 302. For example, the LWD orchestrator circuitry 318 may generate reports indicative that an upgrade was successful or unsuccessful. In some examples, the LWD orchestrator circuitry 318 generates reports indicative of resource usage after the operation was applied (e.g., CPU usage, memory capacity, etc.). The example LWD orchestrator circuitry 318 may be implemented by processor circuitry and/or controller circuitry.

In some examples, the LWD orchestrator circuitry 318 includes means for orchestrating operations and/or services. In some examples, the LWD orchestrator circuitry 318 may be implemented by machine executable instructions such as that implemented by at least blocks 610 and/or 612 of FIG. 6 executed by processor circuitry, which may be implemented by the example processor circuitry 812 of FIG. 8, the example processor circuitry 900 of FIG. 9, and/or the example Field Programmable Gate Array (FPGA) circuitry 1000 of FIG. 10. In other examples, the LWD operations bus 316 is implemented by other hardware logic circuitry, hardware implemented state machines, and/or any other combination of hardware, software, and/or firmware. For example, the LWD operations bus 316 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

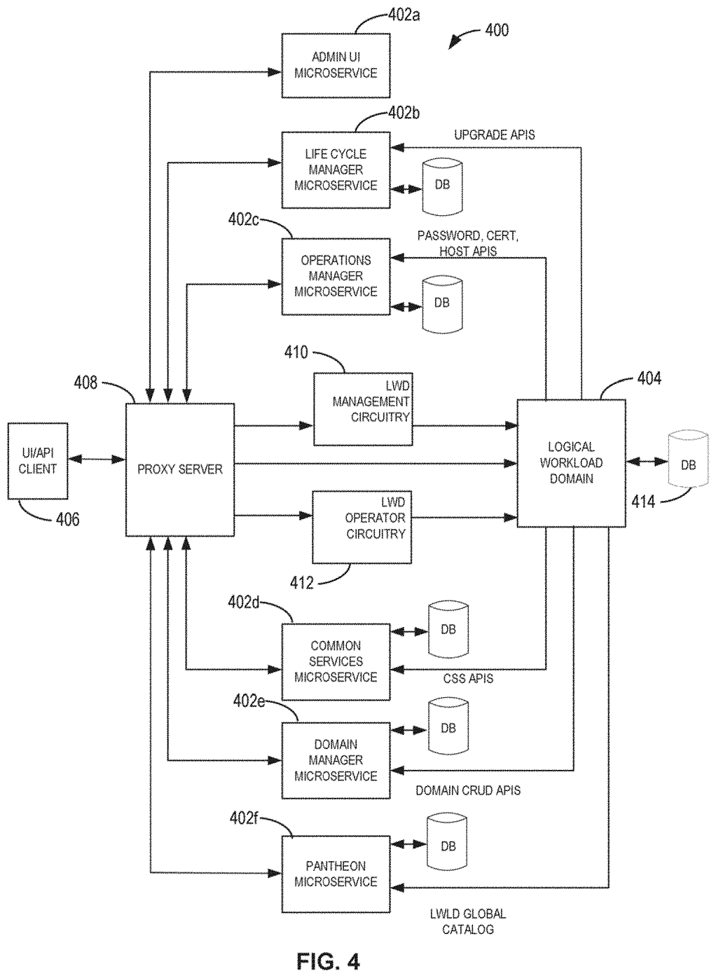

FIG. 4 is an example block diagram of a logical workload domain service interaction 400 to apply and/or utilize microservices 402 for a LWD 404. The example LWD service interaction 400 includes the microservices 402a, 402b, 402c, 402d, 402e, and 402f, collectively microservices 402, the example LWD 404, an example user interface (UI) and/or API client 406, an example proxy server 408, an example LWD management circuitry 410, and an example LWD operator circuitry 412.

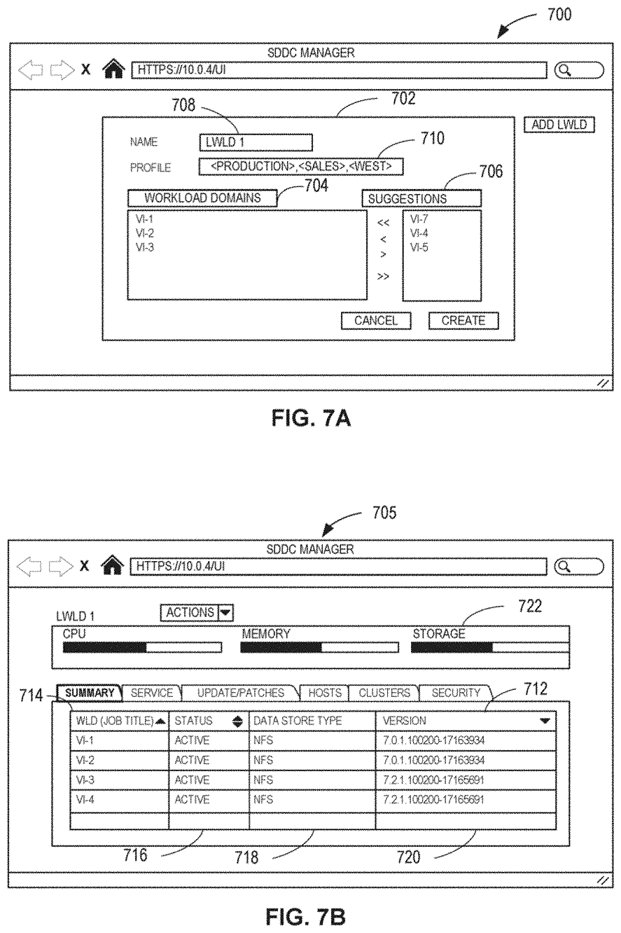

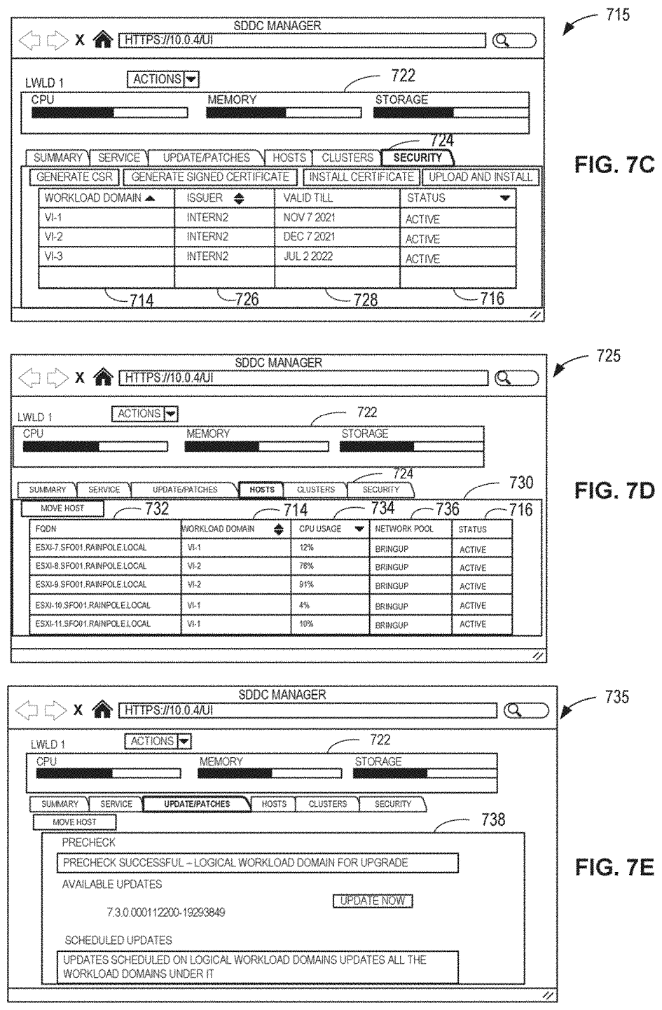

In the illustrated example of FIG. 4, the example microservices 402 are structures of applications that comprise independently deployable, modular services. In the illustrated example of FIG. 4, an example first microservice 402a is an administrator (admin) user interface microservice 402a that provides a user interface visualization, such as the UI visualizations of FIGS. 7A, 7B, 7D, and 7E described in further detail below, to an administrator of the LWD 404. In the illustrated example of FIG. 4, an example second microservice 402b is a lifecycle manager microservice 402b that manages upgrades on the LWD 404. In some examples, the lifecycle manager microservice 402b is the lifecycle management circuitry 112 of FIG. 1. In the illustrated example of FIG. 4, an example third microservice 402c is an operations manager microservice 402c that manages security policies and upgrades on the LWD 404. In some examples, the operations manager microservice 402c is the operations management circuitry 110 of FIG. 1. In the illustrated example of FIG. 4, an example fourth microservice 402d is a common services microservice that includes services that are common across all applications. For example, the fourth microservice 402d includes login services, authentication services, user management services, etc. In the illustrated example of FIG. 4, an example fifth microservice 402e is a domain manager microservice 402e that creates, reads, uploads, and deletes workload domains that are grouped in the LWD 404 and/or independent of the LWD 404. In some examples, the domain manager microservice 402e is the domain management circuitry 108 of FIG. 1. In the illustrated example of FIG. 4, an example sixth microservice 402f is a pantheon microservice that stores and leverages data of workload domains deployed across the different cities, different states, and/or different countries.

In the illustrated example of FIG. 4, the LWD 404 includes a logical group of at least two or more workload domains that can be managed as a single unit. For example, any of the example microservices 402 can apply corresponding services to the workload domains, grouped in the LWD 404, at the same time and/or an approximately same time.

In the illustrated example of FIG. 4, the example UI/API client 406 is software and/or hardware circuitry that enables a user to access and/or launch the example first microservice 402a (e.g., the admin UI microservice). For example, a user can utilize the UI/API client 406 to call the first microservice 402a. In some examples, the UI/API client 406 is an interface between a user's computer and the server hosting the example admin UI microservice 402a.

In the illustrated example of FIG. 4, the example proxy server 408 is a server that obtains requests from clients, such as user computing devices, sends the requests to one or more servers hosting the microservices 402, and subsequently delivers the servers' responses back to the UI/API client 406. In some examples, the proxy server 408 communicates requests directly to the LWD 404. Additionally and/or alternatively, the proxy server 408 communicates requests to LWD management circuitry 410 and/or the LWD operator circuitry 412. In some examples, the proxy server 408 includes management circuitry that is to direct the requests to the appropriate receiving server. Additionally and/or alternatively, the proxy server 408 includes logic to read the requests and direct them to an intended receiving server. In the illustrated example of FIG. 4, the example proxy server 408 is implemented by a Reverse Proxy Server. Additionally and/or alternatively, the proxy server 408 may be implemented by any type of server and/or interface.

In the illustrated example of FIG. 4, the example LWD management circuitry 410 is to configure and deploy the LWD 404. In some examples, the LWD management circuitry 410 is the LWD management circuitry 102 of FIG. 1. The example LWD management circuitry 410 obtains requests from the example proxy server 408 that correspond to deploying workload domains, re-configuring workload domains, moving workload domains to different LWDs, and removing workload domains from the LWD 404.

In the illustrated example of FIG. 4, the example LWD operator circuitry 412 is to facilitate applying security policies, managing upgrades, performing backup and restore operations, and applying compliance updates at the LWD 404. The example LWD operator circuitry 412 is the example LWD operator circuitry 104 of FIG. 1. In the illustrated example of FIG. 4, the example proxy server 408 directs requests corresponding to security policies, upgrades, backup/restore operations, etc., to the example LWD operator circuitry 412.

In the illustrated example of FIG. 4, the example LWD 404 is coupled to an example datastore 414. The example datastore 414 includes and/or stores reference configuration templates (workload domain configuration templates). The datastore 414 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 414 may additionally or alternatively be implemented by one or more double data rate (DDR) memories, such as DDR, DDR2, DDR3, DDR4, mobile DDR (mDDR), etc. The datastore 414 may additionally or alternatively be implemented by one or more mass storage devices such as hard disk drive(s), compact disk (CD) drive(s), digital versatile disk (DVD) drive(s), solid-state disk drive(s), etc. While in the illustrated example the datastore 106 is illustrated as a single datastore, the datastore 414 may be implemented by any number and/or type(s) of datastores. Furthermore, the data stored in the datastore 414 may be in any data format such as, for example, binary data, comma delimited data, tab delimited data, structured query language (SQL) structures, etc.

In an example operation of the LWD service interaction 400, the example UI/API client 406 obtains a request to launch the example admin UI microservice 402a. The example proxy server 408 provides the request the admin UI microservice 402a. The example admin UI microservice 402a provides a user interface visualization, such as the UI visualizations of FIGS. 7A, 7B, 7D, and 7E described in further detail below, to a user computing device requesting the service. In some examples, the proxy server 408 delivers the user interface visualization to the UI/API client 406 for providing to the user computing device.

In the example operation of the LWD service interaction 400, the UI/API client 406 obtains a request to perform an upgrade on the example LWD 404, in response to providing the user interface visualization. The example proxy server 408 obtains the request and directs the request to the example LWD operator circuitry 412. The example LWD operator circuitry 412 identifies a number of workload domains that are to be upgraded in the LWD 404. For example, the LWD operator circuitry 412 analyzes the request to determine upgrade information (e.g., a type or version the workload domain is to be upgrade to and/or from). The example LWD operator circuitry 412 notifies the example LWD 404 of the intended upgrade and the workload domains that are to be upgraded. In some examples, the LWD operator circuitry 412 instructs the LWD 404 to call (e.g., initiate) the lifecycle manager microservice 402b.

The example LWD 404 obtains the request and calls the lifecycle manager microservice 402b to perform the upgrade on the workload domains identified in the request from the LWD operator circuitry 412. The example lifecycle manager microservice 402b performs the upgrade and provides the results of the upgrade to the example proxy server 408. The example proxy server 408 notifies the user computing device, via the UI/API client 406, of the results from the example lifecycle manager microservice 402b.

The example operation of the LWD service interaction 400 is not limited to requests for upgrades to the workload domains. The example LWD service interaction 400 includes a plurality of operations corresponding to any microservice that can be utilized and/or manipulated by the LWD 404, including the ones illustrated in FIG. 4

While an example manner of implementing the LWD operator circuitry 104 of FIG. 1 is illustrated in FIG. 3, one or more of the elements, processes, and/or devices illustrated in FIG. 3 may be combined, divided, re-arranged, omitted, eliminated, and/or implemented in any other way. Further, the example upgrade interface 304, the example security interface 306, the example back up restore interface 308, the example compliance interface 310, the example LWD resolver circuitry 312, the example datastore 314, the example LWD operations message bus 316, the example LWD orchestrator circuitry 318, and/or, more generally, the example LWD operator circuitry 104 of FIG. 3, may be implemented by hardware, software, firmware, and/or any combination of hardware, software, and/or firmware. Thus, for example, any of the example upgrade interface 304, the example security interface 306, the example back up restore interface 308, the example compliance interface 310, the example LWD resolver circuitry 312, the example datastore 314, the example LWD operations message bus 316, the example LWD orchestrator circuitry 318, and/or, more generally, the example LWD operator circuitry 104, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example upgrade interface 304, the example security interface 306, the example back up restore interface 308, the example compliance interface 310, the example LWD resolver circuitry 312, the example datastore 314, the example LWD operations message bus 316, and/or the example LWD orchestrator circuitry 318 is/are hereby expressly defined to include a non-transitory computer readable storage device or storage disk such as a memory, a digital versatile disk (DVD), a compact disk (CD), a Blu-ray disk, etc., including the software and/or firmware. Further still, the example LWD operator circuitry 104 of FIG. 1 may include one or more elements, processes, and/or devices in addition to, or instead of, those illustrated in FIG. 3, and/or may include more than one of any or all of the illustrated elements, processes and devices.

Flowcharts representative of example hardware logic circuitry, machine readable instructions, hardware implemented state machines, and/or any combination thereof for implementing the LWD system 100 of FIG. 1 is shown in FIGS. 5-6. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 5 and/or 6. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5-6, many other methods of implementing the example LWD system 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to configure and deploy workload domains and logical workload domains. The machine readable instructions and/or operations 500 of FIG. 5 begin at block 502 at which the, LWD system 100 (FIG. 1) obtains a request to create a logical workload domain including two or more workload domains. For example, the LWD management circuitry 102 (FIGS. 1 and 2) obtains, via the first RW interface 202 (FIG. 2), instructions to create a LWD (e.g., LWD 116a, LWD 116b, LWD 116c). In this example, the request is indicative to create a new LWD. For example the workload domains have not yet been configured and deployed and, thus, the LWD does not exist. Additionally and/or alternatively, the request includes instructions to assign a previously configured workload domain to a previously configured LWD.

The example LWD system 100 requests input information for one of the two or more workload domains (block 504). For example, the LWD management circuitry 102 and/or the example domain orchestrator circuitry 206 (FIG. 2) requires additional information to configure a workload domain. In some examples, a request to create a LWD domain includes some information about the desired workload domain, such as a job of the workload domain (e.g., the intended use of the workload domain), the creator of the workload domain, a cluster name, management and host components, etc. The input information is to assist the LWD management circuitry 102 in configuring the workload domain prior to deployment. In some examples, the input information is to be utilized to create a template for workload domains in the LWD.

The example LWD system 100 generates a first workload domain based on the input information (block 506). For example, the LWD management circuitry 102 and/or the example domain orchestrator circuitry 206 configure and deploy the first workload domain with information specific to the input information. In some examples, the input information includes a domain name, an organization name, a cluster name, a cluster image, a username, a password, and a host configuration protocol (e.g., a static IP address). In some examples, the input information includes an indication to add the first workload domain to the requested LWD. Therefore, the first workload domain is configured to be included in the requested LWD and deployed as a workload domain grouped within the requested LWD.

The example LWD system 100 allocates a host(s) to the first workload domain (block 508). For example, the host orchestrator circuitry 208 (FIG. 2) allocates one or more host(s) that the first workload domain is to execute on and/or consume resources from. In some examples, LWD management circuitry 102 and/or the host orchestrator circuitry 208 is to select one or more available hosts for the first workload domain based on the host configuration protocol. Additionally and/or alternatively, the example host orchestrator circuitry 208 is to select one or more available hosts based on the available resources of the host, a priority of the job of the first workload domain (e.g., a high priority job that should have a lot of resources, a low priority job that has the bandwidth to share resources, etc.), etc.

The example LWD system 100 extracts information from the first workload domain, the information corresponding to a workload domain configuration (block 510). For example, the LWD management circuitry 102, the LWD reference management circuitry 210 (FIG. 2), and/or the example workload domain reference repository 214 (FIG. 2) copy information from the configuration of the first workload domain. In some examples, the copied information includes a domain name, an organization name, a cluster name, a cluster image, a username, a password, and/or a LWD identifier (e.g., the requested LWD), etc.

The example LWD system 100 generates a reference configuration template for subsequent workload domains based on the extracted information (block 512). For example, the LWD management circuitry 102 and/or the example domain orchestrator circuitry 206 generates a file of pre-configured information that are typically repeated in other workload domains. In some examples, the pre-configured information is associated with the LWD. For example, one reference configuration template is utilized for a first LWD and a different reference configuration template with different pre-configured information is utilized for a second LWD.

The example LWD system 100 stores the reference configuration template (block 514). For example, the LWD management circuitry 102 and/or the domain orchestrator circuitry 206 store the reference configuration template at the workload domain reference repository 214 and/or at the datastore 106 (FIGS. 1 and 2).

The example LWD system 100 determines whether a request is obtained to generate a second workload domain (block 516). For example, the LWD management circuitry 102 and/or the first RW interface 202 (FIG. 2) waits to obtain a request to deploy a second workload domain. In some examples, a request to create the second workload domain is in a queue in response to receiving the request to create the logical workload domain. For example, a user may send a request for a generation of two workload domains. In such an example, the domain orchestrator circuitry 206 retrieves the request from the first RW interface 202 and/or any type of memory (e.g., cache).

In some examples, when the LWD system 100 determines a second request has been obtained (e.g., block 516 returns a value YES), the LWD system 100 identifies a logical workload domain to create the second workload domain (block 518). For example, the LWD management circuitry 102 determines if the request to generate the second workload domain is a request to include the second workload domain in the LWD. In some examples, the request may not indicate that a workload domain is to be included in a LWD and, thus, a logical workload domain is not identified.

The example LWD system 100 determines whether a LWD has been identified (block 520). For example, the LWD management circuitry 102 and/or the domain orchestrator determines whether a description of the second workload domain matches a description of the LWD. Additionally and/or alternatively, the example LWD management circuitry 102 determines whether specific data (e.g., metadata) is included in the request corresponding to the LWD. In some examples, if the LWD system 100 does not identify a LWD (e.g., block 520 returns a value NO), control returns to block 504.

In some examples, if the LWD system 100 does identify a LWD (e.g., block 520 returns a value YES), the example LWD system 100 determines whether an identified LWD corresponds to the first workload domain (block 522). For example, the LWD management circuitry 102 and/or the example domain orchestrator circuitry 206 scans the request to identify data and/or information indicative of a LWD. In some examples, if the LWD system 100 determines that the identified LWD does not correspond to the first workload domain (e.g., block 522 returns a value NO), control returns to block 504.

In some examples, if the LWD system 100 determines that the identified LWD does correspond to the first workload domain (e.g., block 522 returns a value YES), the example LWD system 100 invokes the reference configuration template (block 524). For example, the LWD management circuitry 102 and/or the example reference WLD deployment engine 212 obtains the reference configuration template that includes pre-configured information for workload domains in the LWD.

The example LWD system 100 requests a host configuration protocol (block 526). For example, the LWD management circuitry 102 and/or the example domain orchestrator circuitry 206 requests input information, via the first RW interface 202, corresponding to which host and/or IP address the second workload domain system is to be associated with.

The example LWD system 100 adds the host configuration protocol to the reference template to generate the second workload domain (block 528). For example, the LWD management circuitry 102 and/or the example domain orchestrator circuitry 206 populates the reference configuration template with the specific host configuration protocol. In some examples, by populating the reference configuration template with the host configuration protocol, the reference configuration template becomes a unique workload domain that is ready for deployment. For example, the reference configuration template becomes the second workload domain.

The example LWD system 100 deploys the second workload domain at the LWD (block 530). For example, the LWD management circuitry 102 and/or the example reference WLD deployment engine 212 deploys the second workload domain and associates it with the example LWD. In the illustrated example, the first workload domain and the second workload domain can be consumed as a single resource.

The example LWD system 100 determines whether another workload domain is to be generated (block 532). For example, the domain orchestrator circuitry 206 and/or the LWD reference management circuitry 210 may obtain more requests to configure and deploy workload domains and/or may reference a queue of requests to configure and/or deploy workload domains. If the example LWD system 100 determines another workload domain is to be generated (e.g., block 532 returns a value YES), control returns to block 518.

If the example LWD system 100 determines another workload domain is not to be generated (e.g., block 532 returns a value NO), the example operations 500 end.

FIG. 6 is a flowchart representative of example machine readable instructions and/or example operations 600 that may be executed and/or instantiated by processor circuitry to perform a service on one or more LWDs. The machine readable instructions and/or operations 600 of FIG. 6 begin at block 602 at which the LWD system 100 of FIG. 1 obtains a request to perform a service on a logical workload domain. For example, any of the upgrade interface 304, the security interface 306, the backup restore interface 308, and/or the compliance interface 310 of FIG. 3 may obtain a request, as an API call, to perform a service, such as update security policies, upgrade versions of the LWDs, backup data in the LWDs, etc.

The example LWD system 100 identifies two or more workload domains in the LWD (block 604). For example, the LWD operator circuitry 104 (FIGS. 1 and 3) and/or the example LWD resolver circuitry 312 (FIG. 3) analyzes instructions in the request to identify workload domain identifiers. Additionally and/or alternatively, the example LWD resolver circuitry 312 queries the datastore 314 (FIG. 3) for which workload domains are in and/or correspond to the LWD. In some examples, the LWD resolver circuitry 312 is to identify additional information about the workload domains based on the instructions in the request. For example, if a request is indicative to upgrade workload domains running at version 1.2 to version 1.4, the example LWD resolver circuitry 312 is to identify which workload domains, in the LWD, run at version 1.2.

The example LWD system 100 is to generate a message indicative of the two or more workload domains and the service to be executed (block 606). For example, the LWD operations message bus 316 is to configure and publish a message, such as instructions, a request, etc., based on communication from the LWD resolver circuitry 312. For example, the LWD resolver circuitry 312 is to notify the bus 316 (FIG. 3) of the desired and/or intended service, obtained at block 602, and the appropriate workload domains to apply the service to. In this example, the bus publishes a message and/or instructions indicating the intended service and the selected workload domains.

The example LWD system 100 is to obtain the message (block 608). For example, the LWD operator circuitry 104 and/or the LWD orchestrator circuitry 318 (FIG. 3) is to retrieve and/or obtain the instructions from the bus 316. In some examples, the LWD orchestrator circuitry 318 subscribes to the bus 316 and is notified when new messages are published.

The example LWD system 100 simultaneously and/or concurrently orchestrates the service on each of the two or more workloads (block 610). For example, the LWD operator circuitry 104 and/or the LWD orchestrator circuitry 318 is to apply the service, identified in the message from the bus 316, to all of the workload domains also identified in the message from the bus 316. For example, the LWD operator circuitry 104 and/or the LWD orchestrator circuitry 318 applies the service by identifying the service for each workload domain in the LWD and configuring the service for the workload domains. The example LWD orchestrator circuitry 318 configures the service by generating instructions that include relevant data for the particular workload. For example, one workload domain may need a different upgrade process than a different workload domain, depending on what versions they are operating on. In this example, the LWD orchestrator circuitry 318 includes relevant information in the instructions about what versions the workload domains are operating at and what version the upgrade service is to take them to. The example LWD orchestrator circuitry 318 conveys the instructions to the workload domains.

The example LWD system 100 generates a report including results of the service (block 612). For example, LWD orchestrator circuitry 318 generates reports indicative that an upgrade was successful or unsuccessful. In some examples, the LWD orchestrator circuitry 318 generates reports indicative of resource usage after the operation was applied (e.g., CPU usage, memory capacity, etc.).

The example operations 600 end when the LWD system 100 generates a report. In some examples, the operations 600 may be repeated when the example LWD system 100 obtains a new request to perform a service.

FIGS. 7A, 7B, 7C, 7D, and 7E depict example user interface (UI) visualizations corresponding to an example SDDC manager, which manages the example LWD system 100. FIG. 7A depicts an example first UI visualization 700 corresponding to a creation of a LWD 1. The first UI visualization 700 of the illustrated example of FIG. 7A includes an example visualization pane or window 702 that includes an example workload domain topology 704, an example workload domain suggestion topology 706, an example name input 708, and an example profile description input 710.

In the illustrated example of FIG. 7A, the first UI visualization 700 corresponds to creating virtual infrastructure (VI) domains in the SDDC manager and adding them to LWD 1. The profile description input 710 enables users to include a description of the LWD by inputting the description into the profile description input 710. Such a description enables the LWD system 100 to provide suggestions, in the workload domain suggestion topology 706, for VI domains based on the purpose of VI domain deployment.

FIG. 7B depicts an example second UI visualization 705 corresponding to a deployed LWD 1. The second UI visualization 705 of the illustrated example of FIG. 7B includes an example visualization pane or window 712 that includes an example workload domain list 714, an example workload domain status column 716, an example data store type column 718, and an example workload domain version column 720. The second UI visualization 705 of the illustrated example of FIG. 7B includes an example visualization pane or window 722 that includes a resource consumption view.

In the illustrated example of FIG. 7B, the second UI visualization 705 corresponds to a deployed LWD 1. The example second UI visualization 705 lists all of the VI domains that are a part of the LWD 1. The example second UI visualization 705 also illustrates a view of how much consumption of CPU, memory, and storage that the LWD 1 utilizes.

FIG. 7C depicts an example third UI visualization 715 corresponding to a deployed LWD 1. The third UI visualization 715 of the illustrated example of FIG. 7C includes the example visualization pane or window 722 that includes the resource consumption view. The third UI visualization 715 of the illustrated example of FIG. 7C includes an example visualization pane or window 724 that includes the example workload domain list 714, the example workload domain status column 716, an example issuer column 726, and an example workload domain validity date column 728.

In the illustrated example of FIG. 7C, the third UI visualization 715 corresponds to a deployed LWD 1 after the LWD system 100 applies certificate operations. The example LWD system 100 and/or the example LWD operator circuitry 104 orchestrates the certificate operations on all the resources that are under the LWD 1. In some examples, a report indicative of an aggregation of results of the operation is generated.

FIG. 7D depicts an example fourth UI visualization 725 corresponding to a deployed LWD 1. The fourth UI visualization 725 of the illustrated example of FIG. 7D includes the example visualization pane or window 722 that includes the resource consumption view. The fourth UI visualization 725 of the illustrated example of FIG. 7D includes an example visualization pane or window 730 that includes the example workload domain list 714, the example workload domain status column 716, an example fully qualified domain names (FQDN) address column 732, an example CPU usage column 734, and an example network pool column 736.

In the illustrated example of FIG. 7D, the fourth UI visualization 725 corresponds to the hosts that are a part of the LWD 1 and shown in a host tab. A user and/or the example LWD system 100 utilizes the CPU usage column 734 to sort workload domains and hosts that are underutilized. For example, VI-1 workload domain utilizes less CPU than VI-2 workload domain. In such an example, a user and/or the LWD system 100 and/or the LWD management circuitry 102 moves at least one of the VI-1 workload domains to a VI-2 workload domain. LWDs enable such an operation.

FIG. 7E depicts an example fifth UI visualization 735 corresponding to a deployed LWD 1. The fifth UI visualization 735 of the illustrated example of FIG. 7E includes the example visualization pane or window 722 that includes the resource consumption view. The fifth UI visualization 735 of the illustrated example of FIG. 7E includes an example visualization pane or window 738 that includes an example update report and scheduling.

In the illustrated example of FIG. 7E, the fifth UI visualization 735 corresponds to scheduled updates of the LWD 1. For example, the LWD operator circuitry 104 of FIGS. 1 and 3 may schedule updates that are to occur on the LWD 1. In some examples, the updates are in a queue and scheduled to occur at a specific time. The example LWD system 100 and/or the example LWD operator circuitry 104 orchestrate upgrades of all the VI domains in LWD 1. In some examples, multiple VI domains can be upgraded from the LWD. The example LWD system 100 and/or the example LWD operator circuitry 104 generates a consolidated report of the upgrade and presents the report at the fifth UI visualization 735.

FIG. 8 is a block diagram of an example processor platform 800 structured to execute and/or instantiate the machine readable instructions and/or operations of FIGS. 5-6 to implement the LWD system 100 of FIG. 1. The processor platform 800 can be, for example, a server, a personal computer, a workstation, a self-learning machine (e.g., a neural network), a mobile device (e.g., a cell phone, a smart phone, a tablet such as an iPad™), or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example LWD management circuitry 102, the example LWD operator circuitry 104, the example domain orchestrator circuitry 206, the example host orchestrator circuitry 208, the example LWD reference management circuitry 210, the example reference workload domain deployment engine 212, the example workload domain reference repository 214, the example LWD resolver circuitry 312, the example LWD operations message bus 316, and the example LWD orchestrator circuitry 318.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In this example, the interface circuitry 820 implements the example first RW interface 202, the example second RW interface 204, the example upgrade interface 304, the example security interface 306, the example back up restore interface 308, and the example compliance interface 310.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or a printer. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices, and DVD drives. In this example, the mass storage devices 828 implement the example datastore 106 and the example datastore 314.

The machine executable instructions 832, which may be implemented by the machine readable instructions of FIGS. 5-6 may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5-6.

The cores 902 may communicate by an example bus 904. In some examples, the bus 904 may implement a communication bus to effectuate communication associated with one(s) of the cores 902. For example, the bus 904 may implement at least one of an Inter-Integrated Circuit (I2C) bus, a Serial Peripheral Interface (SPI) bus, a PCI bus, or a PCIe bus. Additionally or alternatively, the bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and an example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The bus 904 may implement at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 5-6 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 5-6. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 5-6. As such, the FPGA circuitry 1000 may be structured to effectively instantiate some or all of the machine readable instructions of the flowcharts of FIGS. 5-6 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 5-6 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIGS. 5-6 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowchart of FIGS. 5-6 may be executed by one or more of the cores 902 of FIG. 9 and a second portion of the machine readable instructions represented by the flowcharts of FIGS. 5-6 may be executed by the FPGA circuitry 1000 of FIG. 10.

In some examples, the processor circuitry 812 of FIG. 8 may be in one or more packages. For example, the processor circuitry 900 of FIG. 9 and/or the FPGA circuitry 1000 of FIG. 9 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

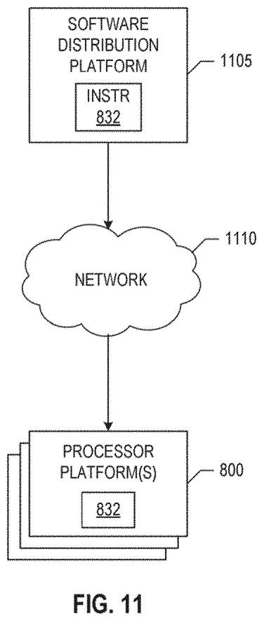

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 500 and 600 of FIGS. 5-6, as described above. The one or more servers of the example software distribution platform 1105 are in communication with a network 1110, which may correspond to any one or more of the Internet and/or any of the example networks 826 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 500 and 600 of FIGS. 5-6, may be downloaded to the example processor platform 800, which is to execute the machine readable instructions 832 to implement the LWD system 100. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that logically group together workload domains to manage workload domains in an efficient manner. The disclosed systems, methods, apparatus, and articles of manufacture improve the efficiency of using a computing device by reducing an amount of computational time it takes a virtual and/or physical server to upgrade, deploy, and/or perform services on workload domains. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to generate and manage logical workload domains in a computing environment are disclosed herein. Further examples and combinations thereof include the following:

Example 1 includes an apparatus comprising at least one memory, instructions in the apparatus, and processor circuitry to execute the instructions to obtain a request to perform a service on a logical workload domain, the logical workload domain logically grouping at least two or more workload domains based on a criterion, identify the at least two or more workload domains grouped in the logical workload domain, and concurrently orchestrate the service on the at least two or more workload domains.

Example 2 includes the apparatus of example 1, wherein the processor circuitry is to execute the instructions to generate a message indictive of the at least two or more workload domains and the service to be executed, the message to indicate ones of the at least two or more workload domains to receive the service.

Example 3 includes the apparatus of example 1, wherein the criterion is an application criterion, the at least two or more workload domains executing a same application.

Example 4 includes the apparatus of example 1, wherein the criterion is a user criterion defined at deployment of the at least two or more workload domains.

Example 5 includes the apparatus of example 1, wherein the service is a first service, the at least two or more workload domains are two or more first workload domains, and the request is a first request to perform the first service to upgrade the at least two or more workload domains, the processor circuitry is to execute the instructions to obtain a second request to perform a second service, the second service to apply a security policy to the two or more first workload domains, and a third request to perform a third service, the third service to create a second workload domain that is to be grouped in the logical workload domain.

Example 6 includes the apparatus of example 5, wherein the processor circuitry is to execute the instructions to invoke a reference configuration template to create the second workload domain that is to be grouped in the logical workload domain, the reference configuration template to provide pre-defined configuration settings for the second workload domain.

Example 7 includes the apparatus of example 1, wherein the processor circuitry is to execute the instructions to identify the at least two or more workload domains based on the service to be performed.

Example 8 includes the apparatus of example 1, wherein the processor circuitry is to identify the at least two or more workload domains by accessing identifying information in the request, submitting a query to a datastore based on the identifying information, and based on the query, identifying the logical workload domain as a target logical workload domain to perform the service.

Example 9 includes the apparatus of example 1, wherein to concurrently orchestrate the service on the at least two or more workload domains, the processor circuitry is to execute the instructions to at least one of configure, coordinate, or manage the service on the at least two or more workload domains.

Example 10 includes a non-transitory computer readable storage medium comprising instructions that, when executed, cause one or more processors to at least obtain a request to perform a service on a logical workload domain, the logical workload domain logically grouping at least two or more workload domains based on a criterion, identify the at least two or more workload domains grouped in the logical workload domain, and concurrently orchestrate the service on the at least two or more workload domains.

Example 11 includes the non-transitory computer readable storage medium of example 10, wherein the instructions, when executed, cause the one or more processors to generate a message indictive of the at least two or more workload domains and the service to be executed, the message to indicate ones of the two or more workload domains to receive the service.

Example 12 includes the non-transitory computer readable storage medium of example 10, wherein the criterion is an application criterion, the at least two or more workload domains executing a same application.

Example 13 includes the non-transitory computer readable storage medium of example 10, wherein the criterion is a user criterion defined at deployment of the at least two or more workload domains.

Example 14 includes the non-transitory computer readable storage medium of example 10, wherein the service is a first service, the at least two or more workload domains are two or more first workload domains, and the request is a first request to perform the first service to upgrade the at least two or more workload domains, the instructions, when executed, cause the one or more processors to obtain a second request to perform a second service, the second service to apply a security policy to the two or more first workload domains, and a third request to perform a third service, the third service to create a second workload domain that is to be grouped in the logical workload domain.

Example 15 includes the non-transitory computer readable storage medium of example 14, wherein the instructions, when executed, cause the one or more processors to invoke a reference configuration template to create the second workload domain that is to be grouped in the logical workload domain, the reference configuration template to provide pre-defined configuration settings for the second workload domain.

Example 16 includes the non-transitory computer readable storage medium of example 10, wherein the instructions, when executed, cause the one or more processors to identify the at least two or more workload domains based on the service to be performed.

Example 17 includes the non-transitory computer readable storage medium of example 10, wherein the instructions, when executed, cause the one or more processors to identify the at least two or more workload domains by accessing identifying information in the request, submitting a query to a datastore based on the identifying information, and based on the query, identifying the logical workload domain as a target logical workload domain to perform the service.

Example 18 includes the non-transitory computer readable storage medium of example 10, wherein to concurrently orchestrate the service on the at least two or more workload domains, the instructions, when executed, cause the one or more processors to at least one of configure, coordinate, or manage the service on the at least two or more workload domains.

Example 20 includes a method comprising obtaining, by executing an instruction with at least one processor, a request to perform a service on a logical workload domain, the logical workload domain logically grouping at least two or more workload domains based on a criterion, identifying, by executing an instruction with at least one processor, the at least two or more workload domains grouped in the logical workload domain, and concurrently orchestrating, by executing an instruction with at least one processor, the service on the at least two or more workload domains.

Example 21 includes the method of example 20, further including generating a message indictive of the at least two or more workload domains and the service to be executed, the message to indicate ones of the at least two workload domains to receive the service.

Example 22 includes the method of example 20, wherein the service is a first service, the at least two or more workload domains are two or more first workload domains, and the request is a first request to perform the first service to upgrade the at least two or more workload domains and further including obtaining a second request to perform a second service, the second service to apply a security policy to the two or more first workload domains, and obtaining a third request to perform a third service, the third service to create a second workload domain that is to be grouped in the logical workload domain.

Example 23 includes the method of example 22, further including invoking a reference configuration template to create the second workload domain that is to be grouped in the logical workload domain, the reference configuration template to provide pre-defined configuration settings for the second workload domain.

Example 24 includes the method of example 20, wherein the identifying of the at least two or more workload domains is based on the service to be performed.

Example 25 includes the method of example 20, wherein the identifying of the at least two or more workload domains includes accessing identifying information in the request, submitting a query to a datastore based on the identifying information, and based on the query, identifying the logical workload domain as a target logical workload domain to perform the service.

Example 26 includes the method of example 20, wherein concurrently orchestrating the service on the at least two or more workload domains includes at least one of configuring, coordinating, or managing the service on the at least two or more workload domains.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
at least one memory;
instructions in the apparatus; and
processor circuitry to execute the instructions to:
obtain a request to perform a service on a logical workload domain, the logical workload domain logically grouping at least two or more workload domains based on a criterion;
identify the at least two or more workload domains grouped in the logical workload domain; and
concurrently orchestrate the service on the at least two or more workload domains.

2. The apparatus of claim 1, wherein the processor circuitry is to execute the instructions to generate a message indictive of the at least two or more workload domains and the service to be executed, the message to indicate ones of the at least two or more workload domains to receive the service.

3. The apparatus of claim 1, wherein the criterion is an application criterion, the at least two or more workload domains executing a same application.

4. The apparatus of claim 1, wherein the criterion is a user criterion defined at deployment of the at least two or more workload domains.

5. The apparatus of claim 1, wherein the service is a first service, the at least two or more workload domains are two or more first workload domains, and the request is a first request to perform the first service to upgrade the at least two or more workload domains, the processor circuitry is to execute the instructions to obtain:
a second request to perform a second service, the second service to apply a security policy to the two or more first workload domains; and
a third request to perform a third service, the third service to create a second workload domain that is to be grouped in the logical workload domain.

6. The apparatus of claim 5, wherein the processor circuitry is to execute the instructions to invoke a reference configuration template to create the second workload domain that is to be grouped in the logical workload domain, the reference configuration template to provide pre-defined configuration settings for the second workload domain.

7. The apparatus of claim 1, wherein the processor circuitry is to execute the instructions to identify the at least two or more workload domains based on the service to be performed.

8. The apparatus of claim 1, wherein the processor circuitry is to identify the at least two or more workload domains by:
accessing identifying information in the request;
submitting a query to a datastore based on the identifying information; and
based on the query, identifying the logical workload domain as a target logical workload domain to perform the service.

9. The apparatus of claim 1, wherein to concurrently orchestrate the service on the at least two or more workload domains, the processor circuitry is to execute the instructions to at least one of configure, coordinate, or manage the service on the at least two or more workload domains.

10. A non-transitory computer readable storage medium comprising instructions that, when executed, cause one or more processors to at least:
obtain a request to perform a service on a logical workload domain, the logical workload domain logically grouping at least two or more workload domains based on a criterion;
identify the at least two or more workload domains grouped in the logical workload domain; and
concurrently orchestrate the service on the at least two or more workload domains.

11. The non-transitory computer readable storage medium of claim 10, wherein the instructions, when executed, cause the one or more processors to generate a message indictive of the at least two or more workload domains and the service to be executed, the message to indicate ones of the two or more workload domains to receive the service.

12. The non-transitory computer readable storage medium of claim 10, wherein the criterion is an application criterion, the at least two or more workload domains executing a same application.

13. The non-transitory computer readable storage medium of claim 10, wherein the criterion is a user criterion defined at deployment of the at least two or more workload domains.

14. The non-transitory computer readable storage medium of claim 10, wherein the service is a first service, the at least two or more workload domains are two or more first workload domains, and the request is a first request to perform the first service to upgrade the at least two or more workload domains, the instructions, when executed, cause the one or more processors to obtain:
a second request to perform a second service, the second service to apply a security policy to the two or more first workload domains; and
a third request to perform a third service, the third service to create a second workload domain that is to be grouped in the logical workload domain.

15. The non-transitory computer readable storage medium of claim 14, wherein the instructions, when executed, cause the one or more processors to invoke a reference configuration template to create the second workload domain that is to be grouped in the logical workload domain, the reference configuration template to provide pre-defined configuration settings for the second workload domain.

16. The non-transitory computer readable storage medium of claim 10, wherein the instructions, when executed, cause the one or more processors to identify the at least two or more workload domains based on the service to be performed.

17. The non-transitory computer readable storage medium of claim 10, wherein the instructions, when executed, cause the one or more processors to identify the at least two or more workload domains by:
accessing identifying information in the request;
submitting a query to a datastore based on the identifying information; and
based on the query, identifying the logical workload domain as a target logical workload domain to perform the service.

18. The non-transitory computer readable storage medium of claim 10, wherein to concurrently orchestrate the service on the at least two or more workload domains, the instructions, when executed, cause the one or more processors to at least one of configure, coordinate, or manage the service on the at least two or more workload domains.

20. A method comprising:
obtaining, by executing an instruction with at least one processor, a request to perform a service on a logical workload domain, the logical workload domain logically grouping at least two or more workload domains based on a criterion;
identifying, by executing an instruction with at least one processor, the at least two or more workload domains grouped in the logical workload domain; and
concurrently orchestrating, by executing an instruction with at least one processor, the service on the at least two or more workload domains.

21. The method of claim 20, further including generating a message indictive of the at least two or more workload domains and the service to be executed, the message to indicate ones of the at least two workload domains to receive the service.

22. The method of claim 20, wherein the service is a first service, the at least two or more workload domains are two or more first workload domains, and the request is a first request to perform the first service to upgrade the at least two or more workload domains and further including:
obtaining a second request to perform a second service, the second service to apply a security policy to the two or more first workload domains; and
obtaining a third request to perform a third service, the third service to create a second workload domain that is to be grouped in the logical workload domain.

23. The method of claim 22, further including invoking a reference configuration template to create the second workload domain that is to be grouped in the logical workload domain, the reference configuration template to provide pre-defined configuration settings for the second workload domain.

24. The method of claim 20, wherein the identifying of the at least two or more workload domains is based on the service to be performed.

25. The method of claim 20, wherein the identifying of the at least two or more workload domains includes:
accessing identifying information in the request;
submitting a query to a datastore based on the identifying information; and
based on the query, identifying the logical workload domain as a target logical workload domain to perform the service.

26. The method of claim 20, wherein concurrently orchestrating the service on the at least two or more workload domains includes at least one of configuring, coordinating, or managing the service on the at least two or more workload domains.
